(19) United States
(12) Patent Application Publication
(10) Pub. No.: US 2008/0231092 A1
(43) Pub. Date: Sep. 25, 2008

(54) Aircraft crashworthy seats

(76) Inventor: Richard F. Silva, Chester Springs, PA (US)

Correspondence Address: Richard F. Silva, 1450 Pikeland Rd., Chester Springs, PA, 19425, US

(21) Appl. No.: 11/725,201

(22) Filed: Mar. 19, 2007

(51) Int. Cl. B60N 2/42; A47C 31/00

(52) U.S. Cl. 297/216.13; 297/216.1; 297/463.1

(57) ABSTRACT

My invention is a new forward or moveable seat and a new aft or fixed seat designed to absorb FAA required horizontal and vertical crash loads without depending on the fuselage crumpling to absorb the energy.

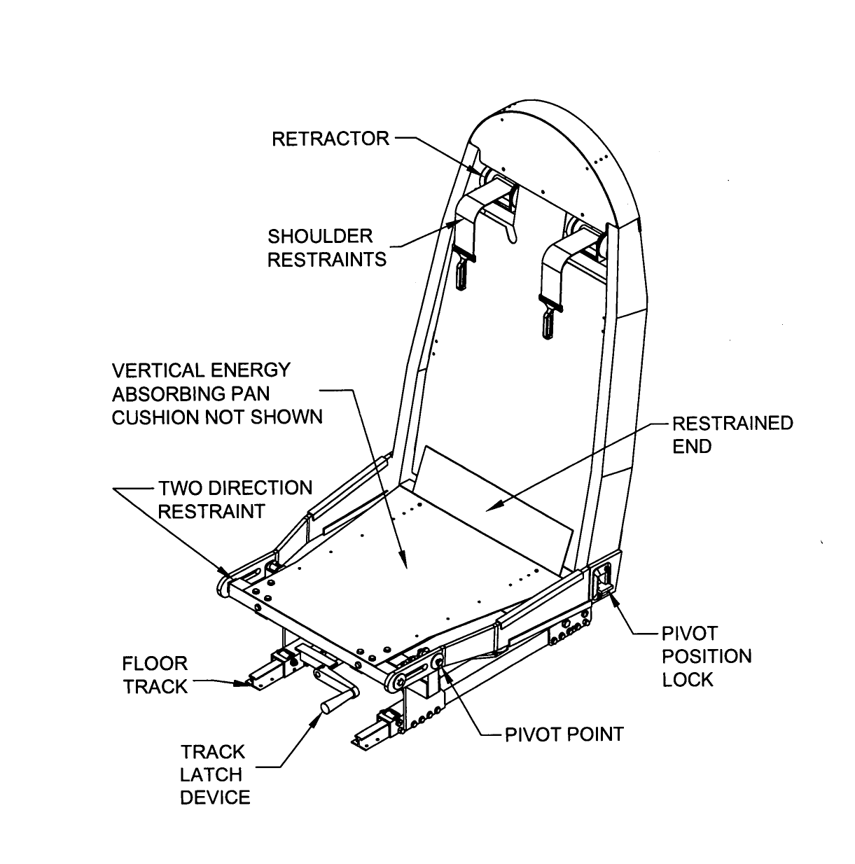

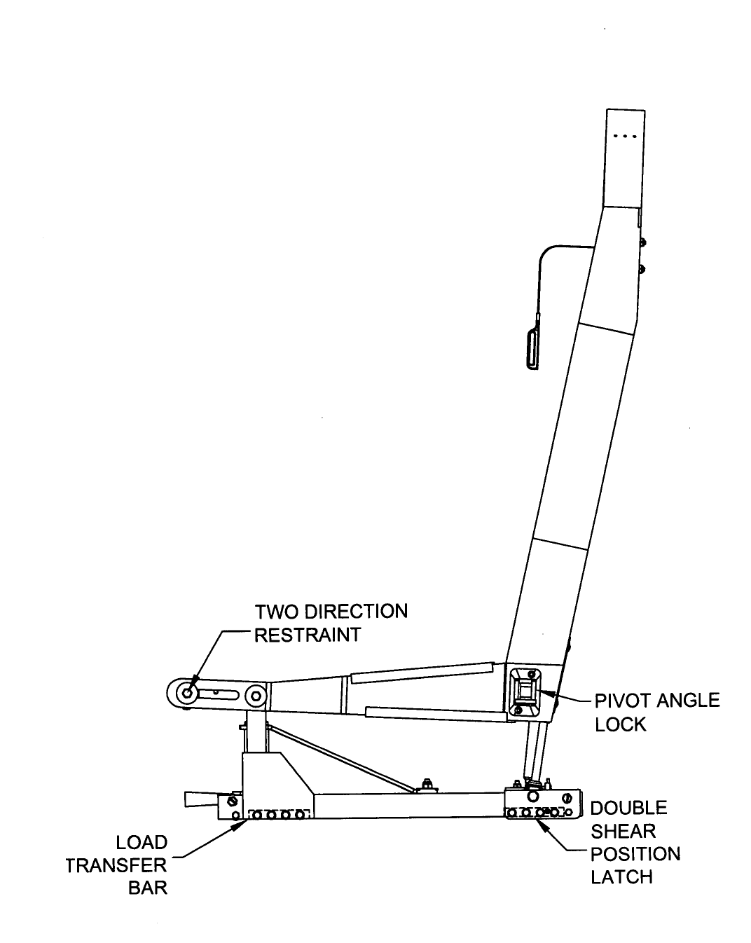

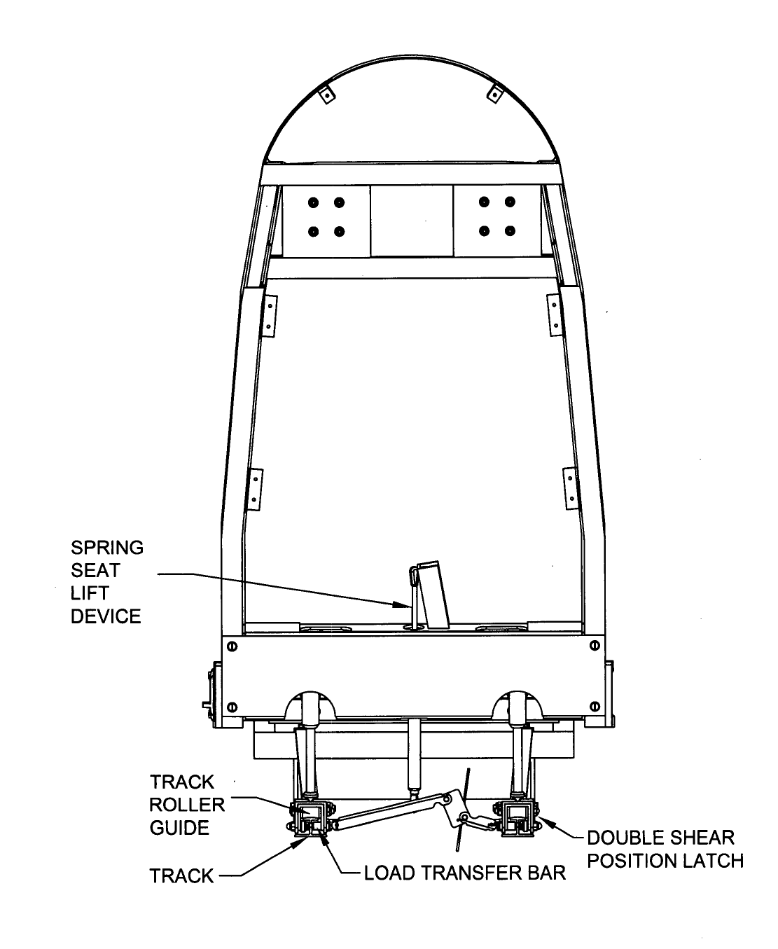

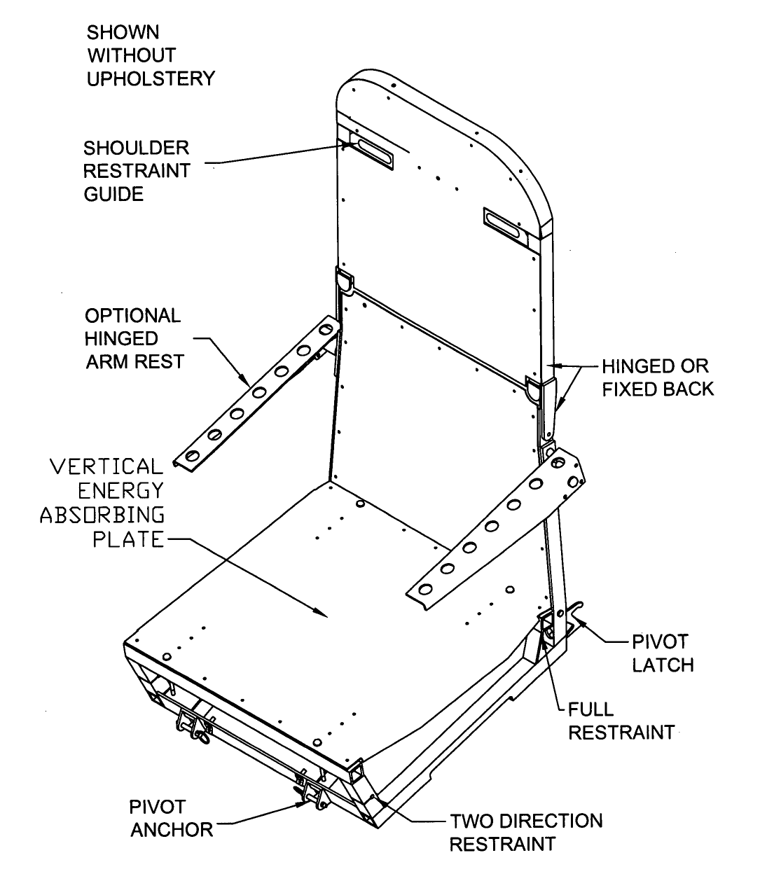

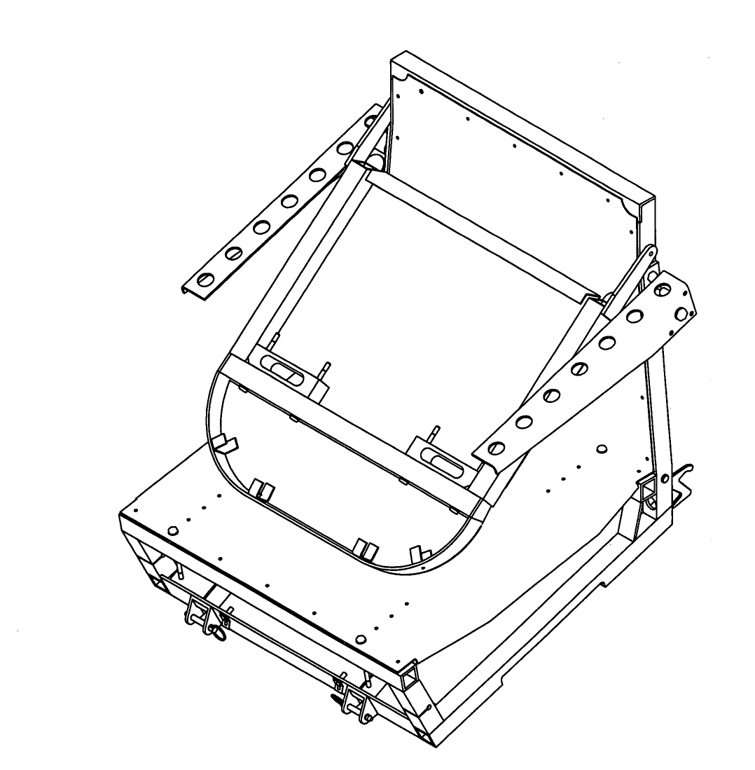

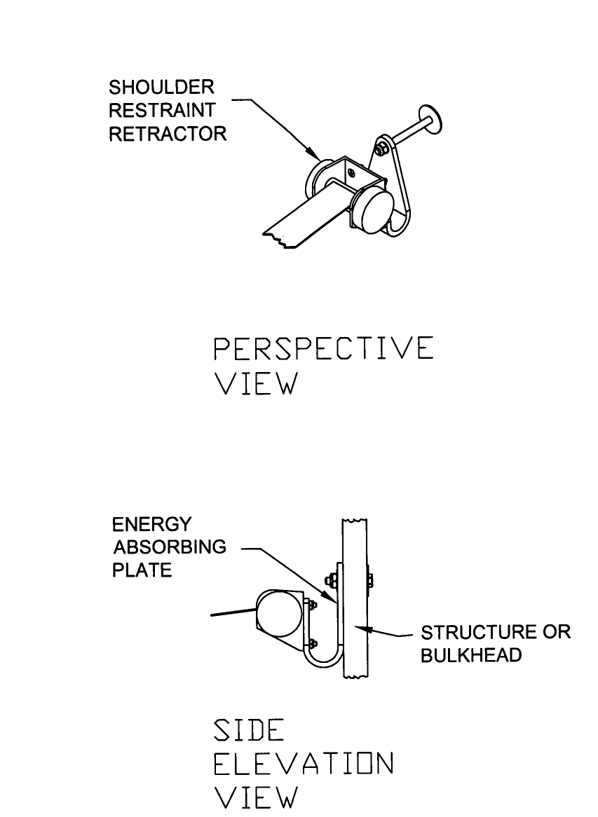

### BACKGROUND OF THE INVENTION

General aviation and commuter type aircraft are required to have crashworthy seats, which must withstand 26 times the force of gravity (26 g) horizontal crash loads and a 19 g vertical crash load on a 60° up angle for the two forward seats.

The remaining seats behind (aft of) the pilot and co-pilot forward seats must withstand a 21 g forward crash load and a 15 g vertical crash load on a 60° up angle.

The seats are required to be tested with an anthropomorphic test dummy (ATD) and the load on the dummy's spine may not exceed 1500 lbs.

The seat lap belt restraint loads must not exceed 2000 lbs. and the shoulder restraint loads must not exceed 1750 lbs. for a single belt or 2000 lbs. total for dual belts. The seats may be designed to withstand the required loads as a separate unit attached to a structure or the seats may be attached to the specific aircraft fuselage to take advantage of the fuselage crumple and energy absorption to pass the tests.

### Problems Meeting the Requirements

The crashworthy requirements prior to 1990 were much less stringent and were easily met by most manufacturers. Because of a slump in aircraft sales in the late 1980s and in the early 1990s, very few newly designed aircraft came to market and the few experienced great difficulty in meeting the requirements. They had to resort to crashing a full cabin/fuselage to meet the requirements.

Prior to 1990, shoulder restraints were not required. In order to meet current requirements, shoulder restraints have to be attached to the overhead or side structure by most manufacturers. Between the dangling shoulder belts and headset wires, general aviation aircraft are cumbersome to enter and exit.

### BRIEF DESCRIPTION OF THE INVENTION

Forward or Moveable Seat

This type of seat is normally used for the pilot and copilot forward seats. It is also designed to be a deluxe moveable passenger seat. It has been designed and tested to absorb a 26 g forward crash and the 19 g vertical 60° up crash load and to absorb the shoulder restraint load into the seatback frame. The shoulder restraints retract into the seat frame and reduce the clutter while entering or exiting the aircraft.

The moveable seat can be positioned for legroom and pivoted into a semi-reclining position for comfort. Optional hinged armrests can be installed for additional comfort on long trips. The open cell seat bottom foam eliminates bottom and leg cramps on long trips.

### Aft or Fixed Passenger Seat

The seat has been designed and tested to absorb the 21 g forward and the 15 g vertical 60° up crash loads.

The seatback can be folding or rigid. The seatback cannot accommodate the shoulder restraint loads. It can accommodate an optional armrest.

### Shoulder Restraint Energy Absorbing Plate

The shoulder belt retractor mounting plate is designed to limit the total belt loads to 2000 lbs. for dual belts or 1000 lbs. each.

### DETAILED DESCRIPTION OF THE INVENTION

My seat invention is designed to absorb the required crash loads with or without having to depend on the energy absorbing crumpling of the fuselage. Thus my seat may be adapted to many aircraft.

### Forward Moveable Seats

My forward two seats (pilot and co-pilot) or aft moveable seats are positioned forward and aft on two floor tracks.

My forward or moveable seats are designed to absorb the shoulder restraint load into the seatback structural frames and to react the load down the frame to the floor track.

The forward or moveable seats are designed to pivot at a forward hinge point to enable the seat to recline. A gas or spring device supports the occupant's weight and a position lock releases the seat and relocks it in the new position.

The seat bottom pan is designed to absorb the vertical energy by allowing the metal pan to both stretch and deform into a catenary shape with one end fully restrained and the other end restrained in two directions.

The seat bottom is cushioned with open cell energy absorbing foam.

The seat is designed with or without an armrest.

### Aft or Fixed Seats

My aft seats are designed to absorb the crash loads with or without depending on the energy absorbing crumpling of the fuselage.

The aft seats are fix pinned to the floor or floor track.

The aft seats can be pinned with a latch to enable the seat to pivot forward.

The aft seatback is also designed for a rigid or folding seatback to pivot forward for greater access behind.

The aft seats are designed with or without arm rests.

The seat bottom pan is designed to absorb the vertical energy by allowing the metal pan to both stretch and deform into a catenary shape with one end fully restrained and the other end restrained in two directions.

The seat bottom is cushioned with open cell energy absorbing foam.

The shoulder restraints for the rear seats are designed to attach to the fuselage structure. My energy absorber mounting plate is designed to limit the shoulder belt tension to 1200 lbs.

### BRIEF DESCRIPTION OF THE SEVERAL VIEWS OF THE DRAWINGS

DRAWING 1: FORWARD SEAT PERSPECTIVE VIEW

The Perspective View depicts the forward seat in its normal position without the upholstery and armrest.

DRAWING 2: SIDE ELEVATION VIEW

The Side Elevation View depicts the floor track lock and the pivot lock mechanism with the spring support.

DRAWING 3: REAR ELEVATION VIEW

The Rear Elevation View depicts the floor track double shear lock and the load transfer bars and position latch.

DRAWING 4: AFT SEAT PERSPECTIVE VIEW

The Perspective View depicts the aft seat in its normal position without the upholstery and with the optional armrest.

DRAWING 5: AFT SEAT PERSPECTIVE VIEW

The Perspective View depicts the aft seat in its optional folded position.

DRAWING 6: ENERGY ABSORBING PLATE PERSPECTIVE VIEW

The Perspective View depicts the energy absorbing mounting plate attached to the fuselage bulk head with the shoulder restraint attached. A detail of the energy absorbing plate is shown.

What I claim my invention is: Forward Moveable Seat

1. Vertical energy absorbing seat bottom pan with one end fixed and the other end restrained in two directions.

2. Seat bottom frame with double shear position locking pin to absorb horizontal loads.

3. Seat bottom frame pivot mechanism with pivot angle release and lock device.

4. Seatback designed to absorb shoulder retractable restraints loads and load transfer device to the floor track.
AFT or Fixed Passenger Seat

1. Vertical energy absorbing seat bottom pan with one end fixed and the forward end restrained in two directions.

2. Fixed or folding seat back with or without armrest.

3. With or without pivoting base anchor.
Energy Absorbing Shoulder Prestraint Rectractor Mounting Plate

1. Plate shape and design.
